(19) United States
(12) Patent Application Publication
(10) Pub. No.: US 2026/0338002 A1
(43) Pub. Date: Oct. 29, 2026

(54) ELECTROMECHANICAL LOCK

(71) Applicant: iLOQ Oy, Oulu (FI)

(72) Inventors: Tommi SINTONEN, Oulu (FI); Matti YLITALO, Oulu (FI); Juha KYRÖNLAMPI, Oulu (FI)

(21) Appl. No.: 19/405,626

(22) Filed: Dec. 2, 2025

Related U.S. Application Data
(63) Continuation-in-part of application No. 17/733,372, filed on Apr. 29, 2022, now Pat. No. 12,509,916.

(51) Int. Cl. E05B 47/00

(52) U.S. Cl. CPC E05B 47/0004; E05B 2047/0054; E05B 2047/0057; E05B 2047/0095

(57) ABSTRACT

An electromechanical lock including a lock cylinder having a core front end and a core back end, and an actuator mechanism configured to switch the electromechanical lock between a locked state and an unlocked state. The electromechanical lock further includes an operation knob, coupled with the core front end, to enable a user to rotate the operation knob from an initial position so that the core front end rotates the core back end from a locked rear position to an unlocked rear position in the unlocked state, and an enforced coupling configured to couple the core front end with the core back end. Rotation of the operation knob from the initial position in the unlocked state is configured to move the enforced coupling to couple the core front end with the core back end and keep them coupled until the operation knob is back in the initial position.

### CROSS REFERENCE TO RELATED APPLICATIONS

This application is a continuation-in-part of U.S. application Ser. No. 17/733,372 filed Apr. 29, 2022, the entire contents of which are hereby incorporated by reference.

### FIELD

Various embodiments relate to electromechanical locks.

### BACKGROUND

Electromechanical locks are emerging to replace traditional mechanical locks. One branch of electromechanical locks are keyless electromechanical locks, wherein instead of having a key, a fixed operation knob may be used. The operation knob may include an antenna to receive the electric energy. The electric energy may be harvested from an NFC (Near-Field Communication) signal transmitted by a user apparatus, for example.

A specific problem relates to the keyless electromechanical locks. In traditional mechanical locks, as the correct key is pushed into the lock cylinder, internal tumblers (pins, discs, levers, or wafers, for example) release internal parts of the lock cylinder coupled with a tailpiece to rotate in unison with the key. As the key can only be removed in one position, it is easy to ensure, that the internal parts (and the tailpiece) are returned to a locked position before the key can be retracted. However, the keyless electromechanical lock operates without the key, and thereby the reset of the lock is a problem.

### BRIEF DESCRIPTION

According to an aspect, there is provided subject matter of independent claims. Dependent claims define some embodiments.

One or more examples of implementations are set forth in more detail in the accompanying drawings and the description of embodiments.

### LIST OF DRAWINGS

Some embodiments will now be described with reference to the accompanying drawings, in which

FIG. 1A, FIG. 1B, FIG. 1C, FIG. 1D, FIG. 1E, FIG. 1F, and FIG. 1G illustrate embodiments of an electromechanical lock cylinder;

FIG. 2A and FIG. 2B illustrate embodiments of an operation knob;

FIG. 3A and FIG. 3B illustrate embodiments of adaptors for the electromechanical lock cylinder;

FIG. 4A, FIG. 4B, and FIG. 4C illustrate embodiments of a return force mechanism of the electromechanical lock cylinder;

FIG. 5A and FIG. 5B illustrate additional embodiments of the return force mechanism; and

FIG. 6A and FIG. 6B, FIG. 7A and FIG. 7B, FIG. 8A and FIG. 8B, and FIG. 9A and FIG. 9B, illustrate pairwise additional embodiments of the return force mechanism and magnetic field forces involved.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the embodiments and in the claims, serve to illustrate the embodiments with reference to the drawings, without limiting it to these examples only.

The embodiments and features, if any, disclosed in the following description that do not fall under the scope of the independent claims are to be interpreted as examples useful for understanding various embodiments of the invention.

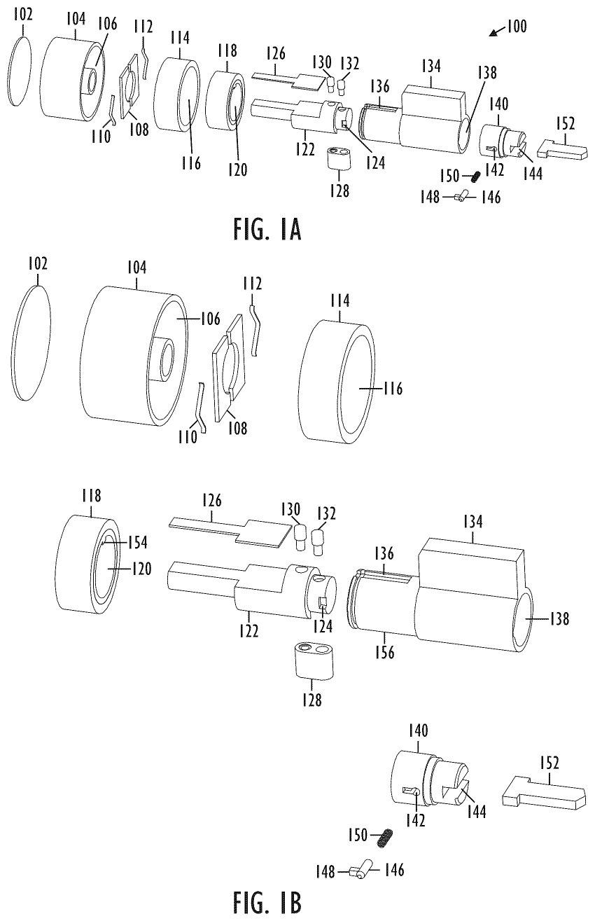

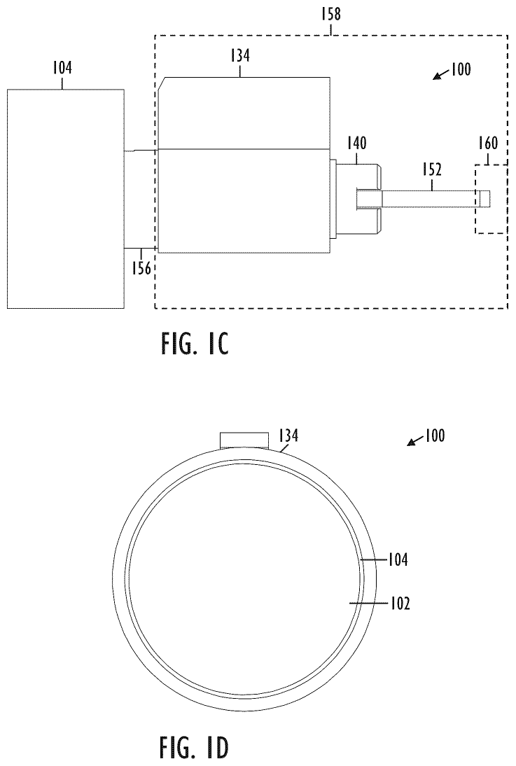

Let us now study an electromechanical lock cylinder 100 with reference to the drawings, wherein various views are illustrated:
FIG. 1A illustrating an exploded view;
FIG. 1B illustrating an enlarged exploded view;
FIG. 1C illustrating an external side view;
FIG. 1D illustrating an external end view towards an operation knob 104;
FIG. 1E illustrating an exploded side view;
FIG. 1F illustrating an exploded top view; and
FIG. 1G illustrating an external end view towards a core back end 140 and a tailpiece 152.

In an embodiment, the electromechanical lock cylinder 100 operates without a key, i.e., as a keyless electromechanical lock cylinder 100.

In an embodiment, the electromechanical lock comprises a lock cylinder 100 having a core front end 122, a core back end 140, an actuator mechanism 126, 128, 132, an operation knob 104, and an enforced coupling 124, 142, 146, 148, 150.

The core back end 140 is coupled with a tailpiece 152. As shown in FIG. 1B, the core back end 140 may include a cut out 144 to receive a matching end of the tailpiece 152.

The tailpiece 152 is coupleable to a bolt mechanism 160.

The actuator mechanism 126, 128, 132 is switchable between a locked state and an unlocked state.

The actuator mechanism 126, 128, 132 is configured:
to keep the core front end 122 uncoupled with the core back end 140 in the locked state;
to couple the core front end 122 with the core back 140 end in the unlocked state to enable the core front end 122 to rotate the core back end 140 from a locked rear position to an unlocked rear position; and
to return to keep the core front end 122 uncoupled with the core back end 140 in the locked state.

The operation knob 104 is coupled with the core front end 122. The operation knob 104 is configured to enable a user to rotate the operation knob 104 from an initial knob position so that the core front end 122 rotates the core back end 140 from the locked rear position to the unlocked rear position in the unlocked state.

In an embodiment, the actuator mechanism 126, 128, 132 switches from the locked state to the unlocked state by coupling the core front end 122 to the core back end 140 by inserting a coupling pin 132 into a notch 164.

In an additional embodiment, the actuator mechanism 126, 128, 132 switches from the locked state to the unlocked state by additionally releasing the core front end 122 to rotate by withdrawing a locking pin 130 from a notch 162 in a core body 134 of the electromechanical lock cylinder 100.

In an embodiment, the actuator mechanism 126, 128, 132 switches from the locked state to the unlocked state by changing an internal magnetic field configuration to operate the coupling pin 132 and the locking pin 130.

In an embodiment, the locking pin 130 and the coupling pin 132 may be housed in a same case 128. The pins 130, 132 may be implemented as moving permanent hard magnets, and the case 128 may comprise stationary permanent semi-hard magnets, whose magnetization configurations may be changed by electrically powered magnetization coils housed in the case 128. With this kind of operation, both pins 130, 132 may move simultaneously.

The core front end 122 and the core back end 140 may be housed in a hollow 138 of a core body 134.

In an embodiment, the electromechanical lock cylinder 100 is configured so that the core body 134 defines its external surface according to a technology standard related to locks. In this way, a standard mechanical lock cylinder may be replaced with the electromechanical lock cylinder 100. ANSI (American National Standards Institute), for example, defines such technology standards. However, the electromechanical lock cylinder 100 may be designed and dimensioned so that instead of a lock standard, the electromechanical lock cylinder 100 may be fitted into a space defined by a proprietary lock specification. In an embodiment, the electromechanical lock cylinder 100 is a key-in-knob (KIK) type cylinder, a key-in-lever (KIL) type cylinder, a mortise cylinder, a rim cylinder, a small format interchangeable core (SFIC) cylinder, or a large format interchangeable core (LFIC) cylinder.

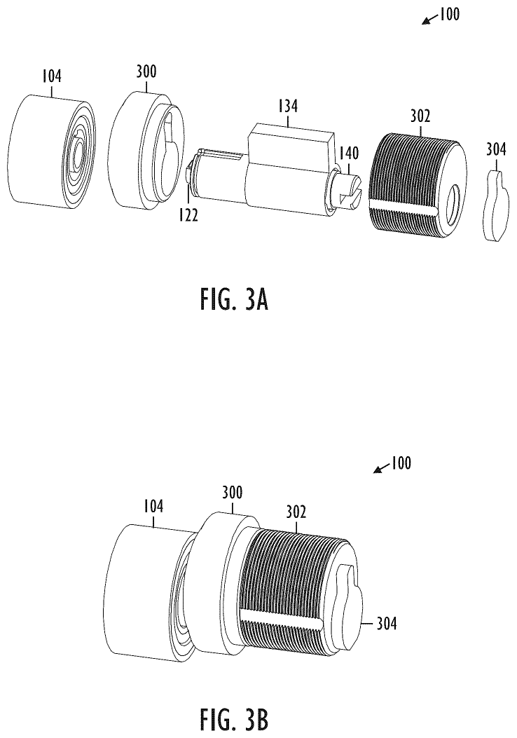

In an embodiment illustrated in FIG. 3A and FIG. 3B, modular parts 300, 302, 306 adapt the electromechanical lock cylinder 100, which is designed as a KIK cylinder so that it may be fitted into an installation requiring a mortise cylinder. With the same principle, other kinds of modular parts may be designed to enable an installation of a general electromechanical lock cylinder 100 in place of various standard or proprietary cylinders.

The above described core mechanism and its operation is described in more detail in other patents and applications by the applicant, such as U.S. Pat. No. 10,443,269 B2 and US 2021/0207399 A1, incorporated herein as references in all jurisdictions where applicable.

In an embodiment, the electromechanical lock cylinder 100 further comprises an antenna 102 in the operation knob 104 to receive wirelessly encrypted data from a portable user apparatus, and a processor 126 to switch the actuator mechanism 126, 128, 132 from the locked state to the unlocked state provided that the received encrypted data matches a predetermined condition. Note that in FIG. 1B, the processor 126 is represented by a printed circuit board, which is then provided with the needed electronics.

In an embodiment, the antenna 102 is further configured to harvest wirelessly electric energy from the portable user apparatus for the operation of the electromechanical lock cylinder 100.

U.S. Pat. No. 11,164,407 B2, another patent of the applicant, incorporated herein as a reference in all jurisdictions where applicable, illustrates operation of the Near-Field Communication (NFC) protocol enabling the wireless communication and energy harvesting of the electromechanical lock cylinder 100.

In an embodiment the electromechanical lock further comprises a return force mechanism 114, 118. With the return force mechanism and/or the enforced coupling, reset of the internals parts of the electromechanical lock cylinder 100 is achieved.

As shown in FIG. 1B, the operation knob 104 may comprise a hollow 106 to house the return force mechanism 114, 118, and fastening parts 108, 110, 112.

In an embodiment, the enforced coupling 124, 142, 146, 148, 150 is configured to couple the core front end 122 with the core back end 140 as the core front end 122 starts to rotate the core back end 140 away from the locked rear position in the unlocked state and decouple the core front end 122 from the core back end 140 as the core back end 140 returns to the locked rear position.

The enforced coupling is configured to couple, in addition to the actuator mechanism, the core front end with the core back end in the unlocked state when the operation knob is rotated from the initial position by the user. The rotation of the operation knob rotates the core front end that is transferred to the core back end in the unlocked state due to the actuator mechanism that couples the core front end and the core back end. The rotation of the core front and back ends is configured to move the enforced coupling to couple the core front end and the core back end and keep them coupled until the operation knob is back in the initial position.

As described above, the core front end may be coupled with the core back end by the actuator mechanism in the unlocked state allowing the core front end to rotate the core back end to set it from the locked rear position to the unlocked rear position. The actuator mechanism switches from the locked state to the unlocked state by changing the internal magnetic field configuration to operate the coupling pin, for example. In addition to the actuator mechanism, the core front end may also be coupled with the core back end by the enforced coupling in the unlocked state. The activation of the enforced coupling may be performed by rotating the core front and/or back end in the unlocked state. The rotation of the core front and/or back end forces the enforced coupling to move such that it couples the core front and back ends, then the core front and back ends are coupled also by the enforced coupling.

In an embodiment, the actuator mechanism is configured to keep the electromechanical lock in the unlocked state for a predetermined period of time. After the predetermined period, the actuator mechanism is configured to return the electromechanical lock to the locked state. In other words, the duration for which the electromechanical lock remains in the unlocked state may be time-limited. As described above, switching between the locked and unlocked states may be performed by coupling and uncoupling the core front end and the core back end, meaning that after the predetermined period, the core front end may be uncoupled from the core back end. This may lead to a situation in which the core back end does not return to the locked rear position from the unlocked rear position together with the core front end due to the uncoupling. The enforced coupling is configured to keep the core front end coupled with the core back end all the time when the operation knob is deviated (rotated) from its initial position, and to release the coupling when the operation knob is back in the initial position. This ensures, despite the functioning of the actuator mechanism, that the core back end will return to the locked rear position together with the core front end. Therefore, the enforced coupling couples the core front end with the back end in the unlocked state always when the operation knob is rotated (deviated) from its initial position, and uncouples the core front end with the back end when the operation knob is in the initial position.

Referring to FIG. 1F, in an embodiment, the enforced coupling is arranged to move unparallel to the actuator mechanism. The enforce coupling may move perpendicularly in relation to the actuator mechanism.

In an embodiment, the enforced coupling, when coupling or uncoupling the core front end with the core back, is configured to move radially or axially in relation to the lock cylinder. Hence, the enforced coupling may move along or towards a longitudinal central axis of the lock cylinder.

In an embodiment, the enforce coupling is within the core back end. Hence, when the core front end rotates the core back end in the unlocked state, the rotation of the back end moves the enforced coupling to couple the core back end with the core front end. As shown in an embodiment of FIG. 1F, the enforced coupling may be implemented as a pin 146 movable in a slot 142 of the core back end 140. The pin 146 retracts in the slot 142 against a spring 150 from a notch of the core body 166 as the cylinder is rotated, and a protrusion 148 of the pin 146 enters a notch 124 in the core front end 122, thereby coupling the core front end 122 with the core back end 140. As the core back end 140 is rotated to the locked rear position by the core front end 122, the spring 150 pushes the pin 146 back into the 166 notch, thereby releasing the enforced coupling. The core front and back end comprise an overlapped section as illustrated in FIG. 1F. The core front end may enter partly inside the core backend forming the overlapped section. The slot in which the pin moves may be placed in the core back end such that it is out of the overlapped section. This means that the pin also moves within the core backend and outside of the overlapped section. The protrusion of the pin extends from the core back end towards the core front end and reaches the overlapped section. Also, the notch in the core front end is in the overlapped section. Hence, when the core back end is rotated, the protrusion can enter the notch to couple the core front and back end. When the slot is in the core back end and out of the overlapped section, the slot can be deeper enabling use of the longer spring to provide more returning force. The returning force is essential from a safety point of view, as it ensures proper retraction of the protrusion from the notch to uncouple the core front and back ends when the operation knob is returned to its initial position.

In an embodiment, the return force mechanism 114, 118 is configured to rotate the operation knob 104 further after the user first has rotated the operation knob 104 away from the initial knob position and then released the operation knob 104, whereby the core back end 140 is rotated to the locked rear position by the core front end 122 due to the coupled enforced coupling 124, 142, 146, 148, 150. The term “further” may be interpreted such that the operation knob is rotated towards the initial position. Hence, the return force mechanism is configured to set (return) the operation knob back to the initial position after the user has released the operation knob. The return force mechanism may also enable the operation knob, while returning to the initial position, to rotate either clockwise or counterclockwise (i.e. in both directions).

In an embodiment, the return force mechanism comprises a first magnetic part 114 coupled with the operation knob 104, and a second magnetic part 118 coupled with a core body 134 of the electromechanical lock cylinder 100, wherein an interaction between a first magnetic force field of the first magnetic part 114 and a second magnetic force field of the second magnetic part 118 rotates the operation knob 104 further, whereby the core back end 140 is rotated to the locked rear position by the core front end 122 due to the coupled enforced coupling 124, 142, 146, 148, 150. As shown in an embodiment of FIG. 1B, the second magnetic part 118 may comprise a protrusion 154 to enter a counterpart groove 136 in the core body 134. The protrusion 154 may be formed into a separate ring fixed against the inner wall of the second magnetic part 118.

In an embodiment, the first magnetic part is configured as an outer magnetic ring 114 coupled with the operation knob 104, and the second magnetic part is configured as an inner magnetic ring 118 coupled with the core body 134 of the electromechanical lock cylinder 100.

In an embodiment, the inner magnetic ring 118 is positioned in a bore 116 of the outer magnetic ring 114.

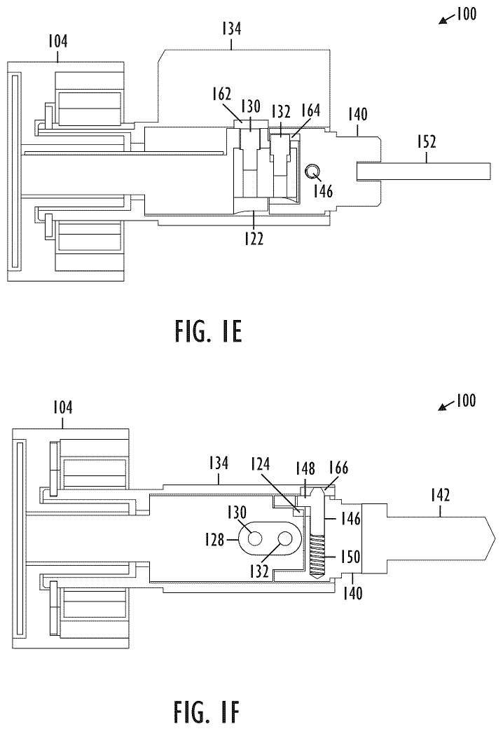

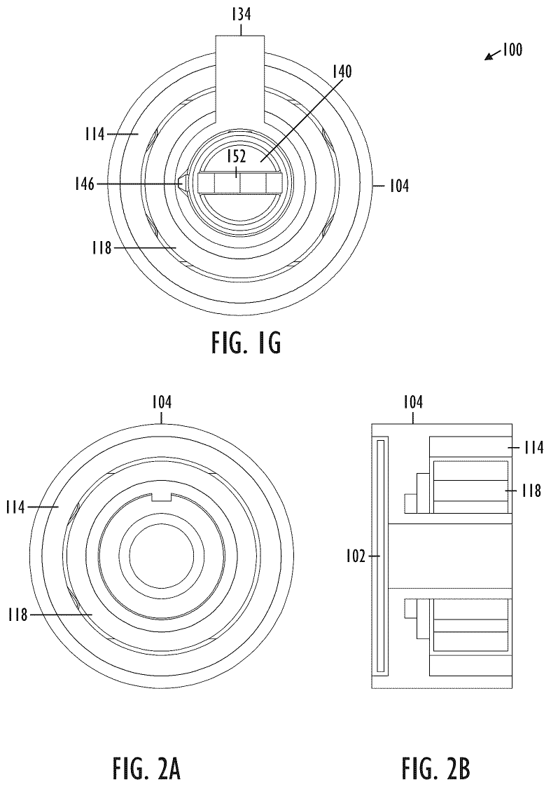

FIG. 2A illustrates an exploded view of the operation knob 104 viewed towards an end of the operation knob 104 so that the inner magnetic 118 and the outer magnetic ring 114 are visible. FIG. 2B illustrates an exploded view of the operation knob 104 viewed from the side.

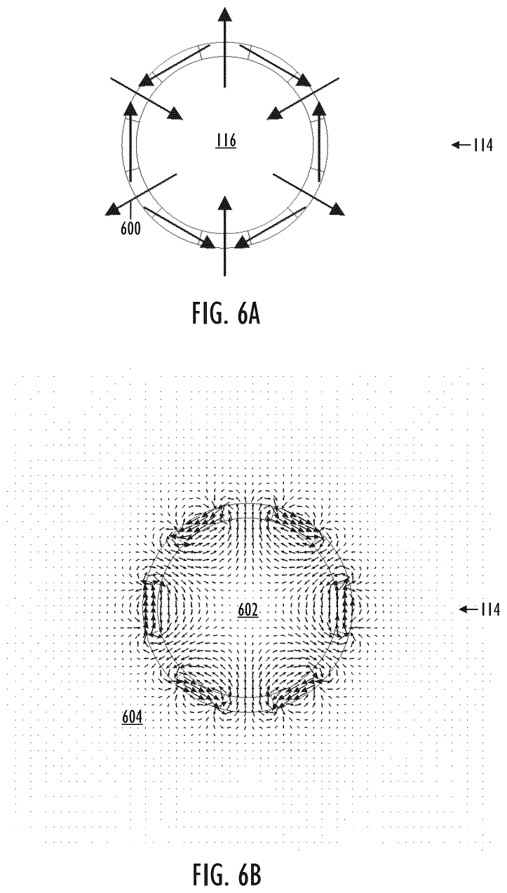

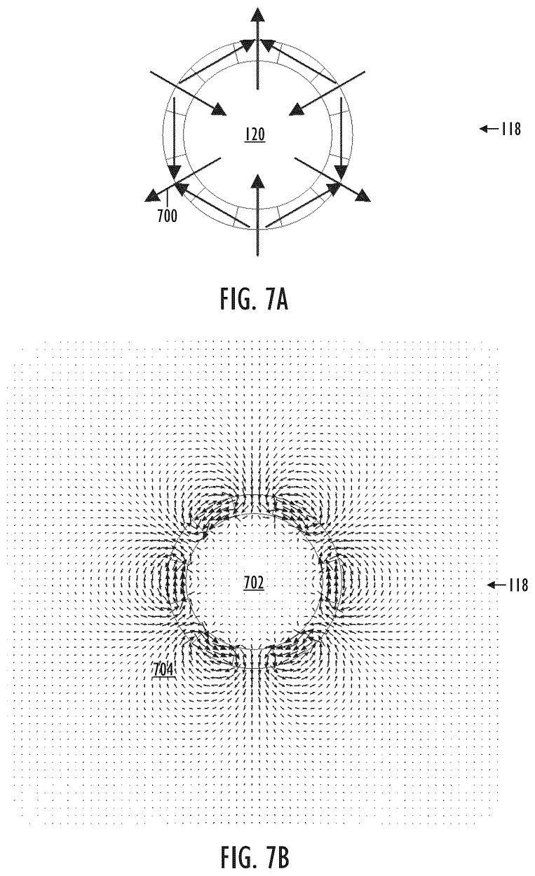

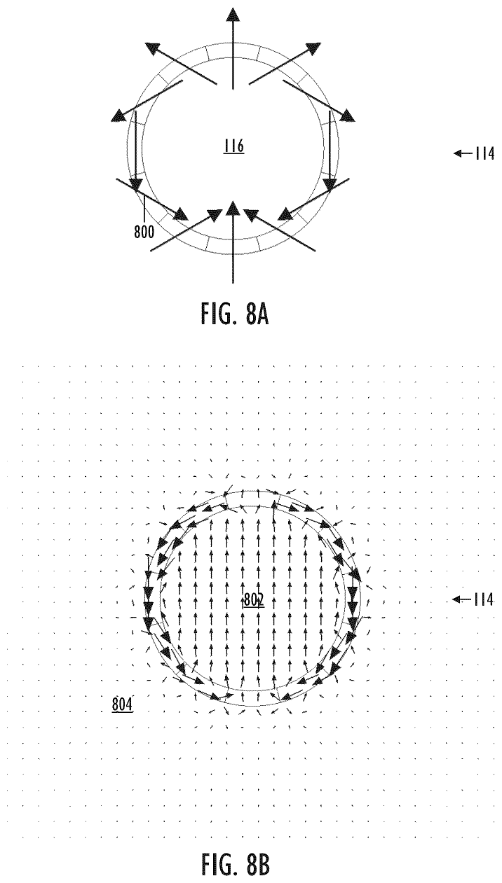

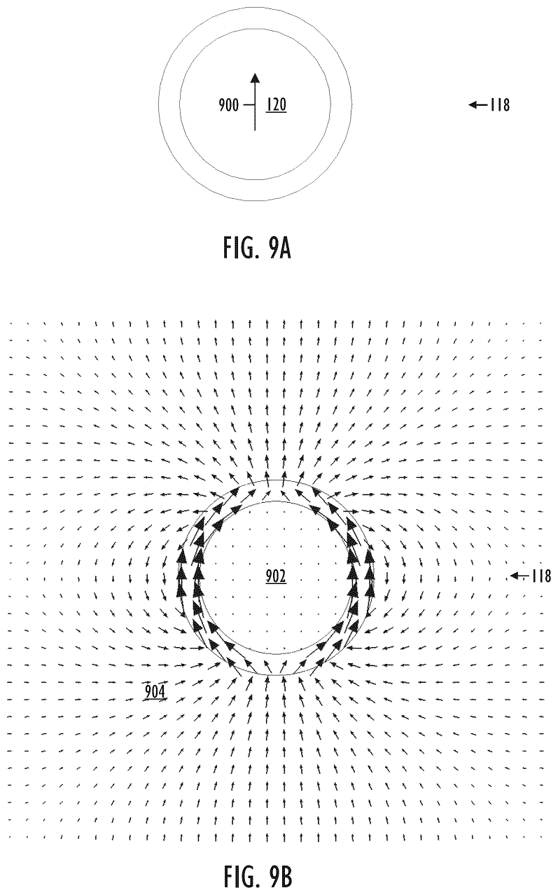

In an embodiment illustrated in FIG. 6A, FIG. 6B, FIG. 7A and FIG. 7B, the outer magnetic ring 114 is arranged as a Halbach cylinder so that a magnetic field is augmented 602 towards a bore 116 of the outer magnetic ring 114 and cancelled 604 towards the operation knob 104, and the inner magnetic ring 118 is arranged as a Halbach cylinder so that a magnetic field is augmented 704 towards the outer magnetic ring 114 and cancelled 702 towards a bore 120 of the inner magnetic ring 118. Arrows 600, 700 illustrate various magnetization patterns creating the magnetic fields 602, 604, 702, 704. In the embodiment illustrated in FIG. 6A and FIG. 6B, the Halbach cylinder has the Halbach cylinder configuration k=4. In the embodiment illustrated in FIG. 7A and FIG. 7B, the Halbach cylinder has the Halbach cylinder configuration k=−4.

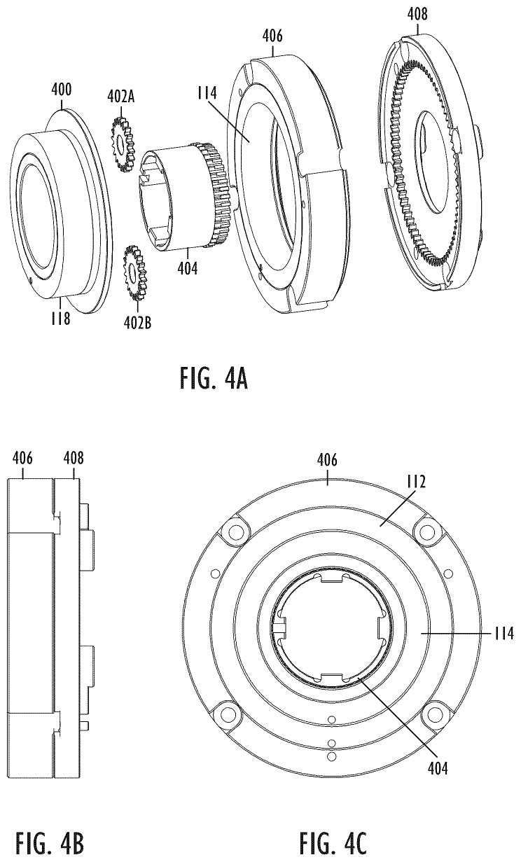

In an embodiment illustrated in FIG. 4A, FIG. 4B and FIG. 4C, the return force mechanism comprises a planetary gear 400, 402A, 402B, 404, 408 to transmit the rotation of the operation knob 104 to the core front end 122 with a gear ratio of 1:n, wherein n is greater than 1 and n is equal to a number of magnetic equilibrium positions for the inner magnetic ring 118 along the outer magnetic ring 114. In the illustrated embodiment, n=3, whereby three magnetic equilibrium positions are realized. The magnetic force field between the first magnetic part 114 and the second magnetic part 118 rotates the operation knob 104 further to one of the magnetic equilibrium positions, whereby the core back end 140 is rotated to the locked rear position by the core front end 122 due to the coupled enforced coupling 124, 142, 146, 148, 150. The planetary gear may be implemented as shown: the inner magnetic ring 118 is fixed to a planetary carrier 400, planetary cogwheels (at least one, in this example three of which two are shown) 402A, 402B, a central sun gear 404 being fixed to the core body 134, the outer magnetic ring 114 is fixed to an external ring 406, and an outer ring 408 with a toothing and fixed to the external ring 406.

In an embodiment illustrated in FIG. 8A, FIG. 8B, FIG. 9A and FIG. 9B, the first magnetic part comprises an outer magnetic ring 114 coupled with the operation knob 104 to create an uniform magnetic force field 802 inside of a bore 116 of the outer magnetic ring 114, and the second magnetic part comprises an inner dipole magnet 118 in the bore 116 of the outer magnetic ring 114 and coupled with the electromechanical lock cylinder 100, wherein an interaction between the uniform magnetic force field of the outer magnetic ring 114 and a magnetic force field 906 of the inner dipole magnet 118 rotates the operation knob 104 further to the one and only magnetic equilibrium position for the inner dipole magnet 118 along the outer magnetic ring 114, whereby the core back end 140 is rotated to the locked rear position by the core front end 122 due to the coupled enforced coupling 124, 142, 146, 148, 150. As there is only one equilibrium position, this embodiment operates without any gearing (such as the planet gearing of FIG. 4A, FIG. 4B and FIG. 4C). Arrows 800 illustrate various magnetization patterns creating the magnetic fields 802, 804. In the embodiment illustrated in FIG. 8A and FIG. 8B, the Halbach cylinder has the Halbach cylinder configuration k=2. In the embodiment illustrated in FIG. 9A and FIG. 9B, arrow 900 illustrates a magnetization pattern of the inner dipole magnet 118. The inner dipole magnet 118 may be, as shown in FIG. 9A and FIG. 9B, a dipole ring magnet magnetized along a radius.

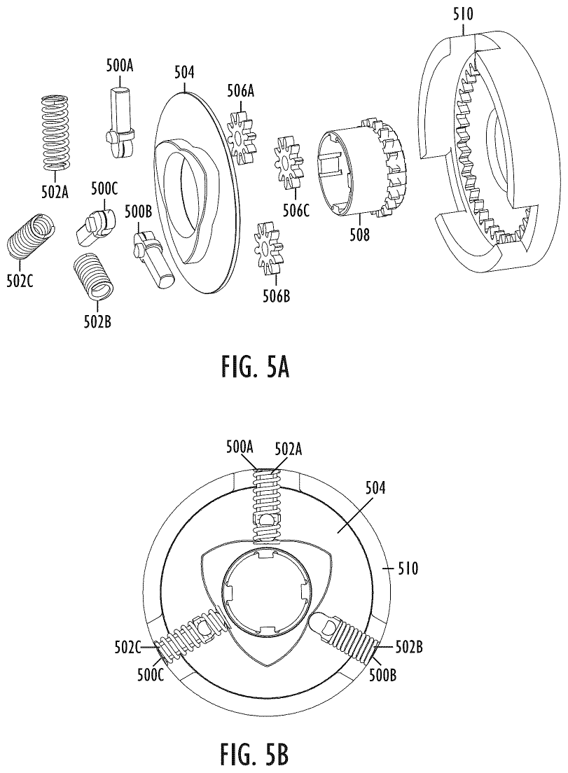

FIG. 5A and FIG. 5B illustrate an alternative embodiment of the return force mechanism operating without magnetic field forces. The embodiment has three equilibrium positions. The return force mechanism comprises three pushers 500A, 500B, 500C with springs 502A, 502B, 502C, a planetary carrier 504 with three cams, planetary cogwheels 506A, 506B, 506C, a central sun gear 508 being fixed to the core body 134, and an external ring 510 with toothing.

In an embodiment illustrated in FIG. 1C, the electromechanical lock cylinder 100 is dimensioned to be accommodated by a housing 158. In a first alternative embodiment also illustrated in FIG. 1C, the electromechanical lock cylinder 100 further comprises a cylinder extension zone 156 of a core body 134 of the electromechanical lock cylinder 100 dimensioned to protrude beyond the housing 158, wherein the operation knob 104 is supported by the cylinder extension zone 156. In a second alternative embodiment (not illustrated), the electromechanical lock cylinder 100 further comprises an external extension zone of a body of the operation knob 104 dimensioned to protrude between the housing 158 and a tapered zone of a core body 134 of the electromechanical lock cylinder 100, wherein the external extension zone is supported by the tapered zone. In a third alternative embodiment (not illustrated), the electromechanical lock cylinder 100 further comprises an internal extension zone of a body of the operation knob 104 dimensioned to protrude between the core front end 122 and a core body 134 of the electromechanical lock cylinder 100, wherein the internal extension zone is supported by the core body 134 of the electromechanical lock cylinder 100.

Even though the invention has been described with reference to one or more embodiments according to the accompanying drawings, it is clear that the invention is not restricted thereto but can be modified in several ways within the scope of the appended claims. All words and expressions should be interpreted broadly, and they are intended to illustrate, not to restrict, the embodiments. It will be obvious to a person skilled in the art that, as technology advances, the inventive concept can be implemented in various ways.

1. An electromechanical lock comprising:
a lock cylinder having a core front end and a core back end;
an actuator mechanism configured to switch the electromechanical lock between a locked state and an unlocked state, wherein the actuator mechanism is configured to keep the core front end uncoupled with the core back end in the locked state, and to couple the core front end with the core back end in the unlocked state to enable the core front end to rotate the core back end from a locked rear position to an unlocked rear position;
an operation knob, coupled with the core front end, to enable a user to rotate the operation knob from an initial position so that the core front end rotates the core back end from the locked rear position to the unlocked rear position in the unlocked state; and
an enforced coupling configured to couple, in addition to the actuator mechanism, the core front end with the core back end, wherein rotation of the operation knob from the initial position in the unlocked state is configured to move the enforced coupling to couple the core front end and the core back end, and keep them coupled until the operation knob is back in the initial position.

2. The electromechanical lock cylinder of claim 1, wherein an enforced coupling is configured to uncouple the core front end with the back end in the initial position of the operation knob.

3. The electromechanical lock cylinder of claim 1, wherein rotation of the operation knob from the initial position is configured to rotate the core front end with the core back end in the unlocked state due to the actuator mechanism, and rotation of the core back end is configured to move the enforced coupling to couple the core front end and the core back end and keep them coupled until the operation knob is back in the initial position.

4. The electromechanical lock cylinder of claim 1, wherein the enforced coupling comprises a pin movable in a slot of the core back end, wherein rotation of the core back end from the locked rear position is configured to retract the pin in the slot against a spring such that a protrusion of the pin enters a notch of the core front end to couple the core front end and the core back end.

5. The electromechanical lock cylinder of claim 4, wherein in the locked rear position of the core backend, the spring pushes the protrusion of the pin out of the notch to uncouple the core front end with the core back end.

6. The electromechanical lock cylinder of claim 4, wherein the core front and back ends are housed in a core body comprising a notch of the core body for the pin, wherein the rotation of the core back end in the unlocked rear position moves the pin out of the notch of the core body and into the slot such that the protrusion of the pin moves into the notch of the core front end, and in the locked rear position, the pin is pushed by the spring into the notch of the core body.

7. The electromechanical lock cylinder of claim 1, wherein electromechanical lock further comprises a return force mechanism configured to rotate the operation knob to the initial position after the user first has rotated the operation knob away from the initial knob position and then released the operation knob.

8. The electromechanical lock cylinder of claim 7, wherein the return force mechanism comprises a first magnetic part coupled with the operation knob, and a second magnetic part coupled with the core body, wherein an interaction between a first magnetic force field of the first magnetic part and a second magnetic force field of the second magnetic part rotates the operation knob towards the initial position when released by the user.

9. The electromechanical lock cylinder of claim 8, wherein the first magnetic part is configured as an outer magnetic ring coupled with the operation knob, and the second magnetic part is configured as an inner magnetic ring coupled with the core body of the electromechanical lock cylinder, wherein the inner magnetic ring is positioned in a bore of the outer magnetic ring.

10. The electromechanical lock cylinder of claim 1, wherein the electromechanical lock comprises a tailpiece coupled with the core backend and couplable to a bolt mechanism.

11. The electromechanical lock cylinder of claim 1, the electromechanical lock cylinder of any preceding claim, wherein the electromechanical lock cylinder is one of a key-in-knob type cylinder, a key-in-lever type cylinder, a mortise cylinder, a rim cylinder, a small format interchangeable core cylinder, a large format interchangeable core cylinder.

12. The electromechanical lock cylinder of claim 1, wherein the actuator mechanism switches from the locked state to the unlocked state by coupling the core front end to the core back end by inserting a coupling pin into a notch.

13. The electromechanical lock cylinder of claim 1, wherein the actuator mechanism switches from the locked state to the unlocked state by additionally releasing the core front end to rotate by withdrawing a locking pin from a notch in a core body of the electromechanical lock cylinder.

14. The electromechanical lock cylinder of claim 12, wherein the actuator mechanism switches, under control of a processor, from the locked state to the unlocked state by changing an internal magnetic field configuration to operate the coupling pin, if received encrypted data matches a predetermined condition.

15. The electromechanical lock cylinder of claim 14, wherein the electromechanical lock comprises an antenna within the operation knob to receive wirelessly the encrypted data and harvest wirelessly electric energy from a portable user apparatus for the operation of the electromechanical lock.
